(19) United States
(12) Patent Application Publication
(10) Pub. No.: US 2004/0227278 A1
(43) Pub. Date: Nov. 18, 2004

(54) Ceramic film manufacturing method, ferroelectric capacitor manufacturing method, ceramic film, ferroelectric capacitor, and semiconductor device

(75) Inventors: Takeshi Kijima, Matsumoto-shi (JP); Eiji Natori, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/793,889

(22) Filed: Mar. 8, 2004

(30) Foreign Application Priority Data
Mar. 10, 2003 (JP) 2003-063169

(51) Int. Cl. C04B 33/32

(52) U.S. Cl. 264/615; 264/621

(57) ABSTRACT

A method of manufacturing a ceramic film including crystallizing a material body including a complex oxide by performing heat treatment on the material body at a pressure of two atmospheres or more. The complex oxide includes lead (Pb) or bismuth (Bi). The material body is a mixture of a sol-gel material and a metallo-organic decomposition material in which at least Pb or Bi in the complex oxide is in an amount of at most 5 percent in excess of Pb or Bi in the stoichiometric composition.

Japanese Patent Application No. 2003-63169, filed on Mar. 10, 2003, is hereby incorporated by reference in its entirety.

### BACKGROUND OF THE INVENTION

The present invention relates to a method of manufacturing a ceramic film, a method of manufacturing a ferroelectric capacitor, a ceramic film, a. ferroelectric capacitor, and a semiconductor device.

As a ferroelectric film applied to semiconductor devices (ferroelectric memory (FeRAM), for example), a ferroelectric film having a perovskite structure (PbZrTiO family, for example) and a ferroelectric film having a layered perovskite structure (BiLaTiO family, BiTiO family, or SrBiTaO family, for example) have been proposed.

Lead (Pb) or bismuth (Bi) contained in the material for the ferroelectric film easily vaporizes at a temperature lower than the crystallization temperature and scatters into the atmosphere during the heat treatment for crystallization. Since defects such as vacancies occur in the crystal if the metal material is insufficient, the metal material such as Pb or Bi is added in an amount of 10% or more in excess of the stoichiometric composition of the ferroelectric in order to compensate for shortages due to vaporization and scattering.

However, Pb or Bi does not necessarily vaporize and scatter during deposition of the ferroelectric film in an amount corresponding to the excess component. The excess component remaining after crystallization may present between the crystals to form an affected layer, thereby adversely affecting the characteristics of the ferroelectric film.

### BRIEF SUMMARY OF THE INVENTION

The present invention may provide methods of manufacturing a ceramic film and a ferroelectric capacitor capable of improving surface morphology, and a ceramic film and a ferroelectric capacitor obtained by these manufacturing methods.

According to one aspect of the present invention, there is provided a method of manufacturing a ceramic film, comprising:

crystallizing a material body including a complex oxide by performing heat treatment on the material body at a pressure of two atmospheres or more, wherein:

the complex oxide includes lead (Pb) or bismuth (Bi) as an element; and

the material body is a mixture of a sol-gel material and an MOD material in which at least Pb or Bi in the complex oxide is in an amount of at most 5 percent in excess of Pb or Bi in the stoichiometric composition.

According to another aspect of the present invention, there is provided a method of manufacturing a ferroelectric capacitor, comprising:

forming a lower electrode over a substrate;

forming a ceramic film over the lower electrode by crystallizing a material body including a complex oxide by performing heat treatment on the material body at a pressure of two atmospheres or more; and

forming an upper electrode over the ceramic film, wherein:

the complex oxide includes lead (Pb) or bismuth (Bi) as an element; and

the material body is a mixture of a sol-gel material and an MOD material in which at least Pb or Bi in the complex oxide is in an amount of at most 5 percent in excess of Pb or Bi in the stoichiometric composition.

### BRIEF DESCRIPTION OF THE SEVERAL VIEWS OF THE DRAWING

FIGS. 1A to 1E show manufacturing steps of a first ferroelectric capacitor according to one embodiment of the present invention.

FIG. 2 shows the heat treatment in manufacturing steps according to a first embodiment of the present invention.

FIG. 3 is a micrograph showing a ceramic film according to the first embodiment.

FIG. 4 shows the heat treatment in manufacturing steps according to Comparative example 1.

FIG. 5A is a graph showing the Raman scattering spectrum of a ceramic film according to the first embodiment; and FIGS. 5B and 5C are graphs each showing the Raman scattering spectrum of a ceramic film according to Comparative example 1.

FIG. 6 is a graph showing hysteresis characteristics of a-ferroelectric capacitor according to the first embodiment.

FIG. 7A is a graph showing hysteresis characteristics of a ferroelectric capacitor according to the first embodiment; and FIG. 7B is a graph showing hysteresis characteristics of a ferroelectric capacitor according to Comparative Example 1.

FIG. 8A is a micrograph showing a ceramic film according to Comparative Example 3; FIG. 8B is a micrograph showing a ceramic film according to a second embodiment of the present invention; and FIG. 8C is a micrograph showing a ceramic film according to Comparative Example 2.

FIG. 9A is a micrograph showing a ceramic film according to Comparative Example 2; FIGS. 9B to 9D are micrographs showing a ceramic film according to the second embodiment; and FIG. 9E is a micrograph showing a ceramic film according to Comparative Example 3.

FIG. 10A is a graph showing hysteresis characteristics of a ferroelectric capacitor according to Comparative Example 2; FIGS. 10B to 10D are graphs showing hysteresis characteristics of a ferroelectric capacitor according to the second embodiment; and FIG 10E is a graph showing hysteresis characteristics of a ferroelectric capacitor according to Comparative Example 3.

FIGS. 11A to 11D are graphs showing temperature characteristics of a ferroelectric capacitor according to the second embodiment.

FIG. 12 is a graph showing temperature characteristics of a ferroelectric capacitor according to the embodiments of the present invention.

FIG. 13A is a graph showing hysteresis characteristics of a ferroelectric capacitor according to Comparative Example 4; and FIG. 13B is a graph showing hysteresis characteristics of a ferroelectric capacitor according to a third embodiment of the present invention.

FIGS. 14A and 14B are graphs showing hysteresis characteristics of a ferroelectric capacitor according to a fourth embodiment.

FIG. 15 shows x-ray diffraction (XRD) patterns of a ceramic film according to a fifth embodiment.

FIG. 16 is a graph showing the relationship between the amount of excess Pb and XRD peak intensity of a ceramic film according to the fifth embodiment.

FIGS. 17A to 17F show manufacturing steps of a second ferroelectric capacitor according to one embodiment of the present invention.

FIG. 18 show the heat treatment in manufacturing steps according to a sixth embodiment.

FIGS. 19A and 19C are graphs showing fatigue characteristics of a ferroelectric capacitor according to Comparative Example 5; and FIGS. 19B and 19D are graphs showing fatigue characteristics of a ferroelectric capacitor according to the sixth embodiment.

FIG. 20 shows a semiconductor device according to Application Example 1.

FIGS. 21A and 21B show the semiconductor device according to Application Example 2.

### DETAILED DESCRIPTION OF THE EMBODIMENTS

According to one embodiment of the present invention, there is provided a method of manufacturing a ceramic film, comprising:

crystallizing a material body including a complex oxide by performing heat treatment on the material body at a pressure of two atmospheres or more, wherein:

the complex oxide includes lead (Pb) or bismuth (Bi) as an element; and

the material body is a mixture of a sol-gel material and an MOD material in which at least Pb or Bi in the complex oxide is in an amount of at most 5 percent in excess of Pb or Bi in the stoichiometric composition.

In this method of manufacturing a ceramic film, the sol-gel material is a material which includes at least either a hydrolysate or a polycondensate of the complex oxide. The MOD material is a material which includes the elements of the complex oxide in an organic solvent.

According to this method of manufacturing a ceramic film, a ceramic film having excellent surface morphology, in which microcrystals are uniformly distributed, can be obtained. The reason therefor is considered to be as follows. Since the mixture of the sol-gel material and the MOD material is used as a material body of the ceramic film, the density of initial crystal nuclei is increased by crystallization of the sol-gel material, and the MOD material is crystallized to fill the gap between the initial crystal nuclei.

Since the mixture of the sol-gel material and the MOD material is adjusted so that at least Pb or Bi among the elements of the complex oxide is included in an amount of at most 5% in excess of the stoichiometric composition, formation of an affected layer due to Pb or Bi remaining in the ceramic film after crystallization of the material body can be reduced.

Scattering of Pb or Bi, which easily volatilizes at low temperature, into the atmosphere can be reduced by performing the heat treatment at a pressure of two atmospheres or more during crystallization of the material body, leading to a high quality ceramic film can be obtained.

This method of manufacturing a ceramic film may have any of the following features.

(A) Each of the sol-gel material and the MOD material may include elements of the complex oxide other than Pb and Bi with the stoichiometric composition.

Since the elements of the complex oxide other than Pb or Bi in the mixture are adjusted to the stoichiometric composition, the MOD material and the sol-gel material complementarily function during crystallization of the material body, whereby the elements included in the complex oxide can be crystallized in an excellent state.

(B) The material body may include a paraelectric material having a catalytic effect on the complex oxide.

Since the paraelectric material is present in the material body in addition to the complex oxide which makes up a ferroelectric, the crystallization temperature can be lowered by replacing part of the elements of the complex oxide by the element of the paraelectric material during the crystallization process of the complex oxide.

The paraelectric material may include an oxide including silicon (Si) or germanium (Ge), or an oxide including Si and Ge, for example.

(C) The heat treatment may be performed in an atmosphere including oxygen having a volume ratio of 10 percent or less by a rapid thermal annealing.

This makes it possible to reduce bonding of oxygen to a metal material such as Pb or Bi, which easily bonds to oxygen at low temperature and easily volatilizes, by limiting the amount of oxygen contained in the atmosphere to 10% or less. Moreover, a highly oriented ceramic film having an excellent crystallization state can be obtained by performing heat treatment using the rapid thermal annealing in which the material body is rapidly heated at several tens of degrees per second or more.

According to one embodiment of the present invention, there is provided a method of manufacturing a ferroelectric capacitor, comprising:

forming a lower electrode over a substrate;

forming a ceramic film over the lower electrode by crystallizing a material body including a complex oxide by performing heat treatment on the material body at a pressure of two atmospheres or more; and

forming an upper electrode over the ceramic film, wherein:

the complex oxide includes lead (Pb) or bismuth (Bi) as an element; and

the material body is a mixture of a sol-gel material and an MOD material in which at least Pb or Bi in the complex oxide is in an amount of at most 5 percent in excess of Pb or Bi in the stoichiometric composition.

In this method of manufacturing a ferroelectric capacitor, since a high quality ceramic film having excellent surface morphology can be obtained in the same manner as in the above method of manufacturing a ceramic film, a ferroelectric capacitor having excellent electrical characteristics can be obtained.

This method of manufacturing a ferroelectric capacitor may have any of the above features (A) to (C) relating to the formation of the ceramic film.

This method of manufacturing a ferroelectric capacitor may further have any of the following features.

(D) A temperature raising step in the heat treatment may be performed at the rate of 100° C./min or less; and a lower alloy film formed of a compound of Pb or Bi in the material body and a metal element of the lower electrode may be formed between the lower electrode and the ceramic film in the temperature raising step.

According to this feature, the metal element which makes up the lower electrode is selected from conventional substances used as electrode materials for the ferroelectric capacitor. For example, Pt, Ir, Al, Au, Ag, Ru, or Sr, or a conductive oxide or a conductive nitride including any of the above elements can be given, but not limited thereto.

According to this feature, a lower alloy film can be formed of a compound of Pb or Bi added to the material body in an amount in excess of the stoichiometric composition of the complex oxide and the metal element which forms the lower electrode at a low temperature by performing the temperature raising step in the heat treatment at a temperature rise rate of 100° C./min or less during formation of the ceramic film.

The lower alloy film can reduce strain caused by the difference in lattice constant between the metal crystal of the lower electrode and the crystal of the ceramic film.

Therefore, a lower alloy film which can improve fatigue characteristics of the ferroelectric capacitor together with crystallization of the material body can be formed without providing an additional step of forming the lower alloy film.

(E) Another heat treatment for recovering ferroelectric characteristics may be performed at two atmospheres pressure or more after forming at least the upper electrode.

According to this feature, the interfacial state between the ceramic film and the upper and lower electrodes can be improved by performing the heat treatment at a pressure of two atmospheres or more as post annealing, whereby the ferroelectric characteristics can be recovered.

(F) A further heat treatment for recovering ferroelectric characteristics may be performed at a pressure of two atmospheres or more after etching at least the ceramic film.

According to this feature, damage caused during the etching step can be recovered by performing the heat treatment at two atmospheres pressure or more as post annealing after etching at least the ceramic film.

The embodiments of the present invention will be described below in more detail with reference to the drawings.

### 1. First Ferroelectric Capacitor

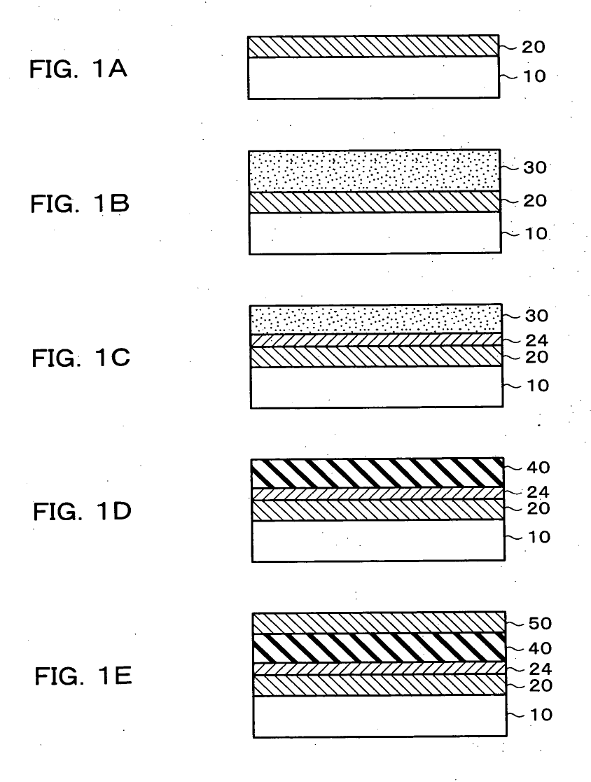

FIGS. 1A to 1E are cross-sectional views schematically showing manufacturing steps of a first ferroelectric capacitor according to one embodiment of the present invention.

As shown in FIG 1A, a lower electrode 20 is formed over a substrate 10. The lower electrode 20 may be formed of a material such as a metal (Pt, Ir, Al, Au, Ag, Ru, or Sr, for example), an oxide conductor (IrOₓ, for example), or a nitride conductor (TiN, for example) by using a sputtering method. The lower electrode 20 may be either a single-layer film or a stacked multilayer film.

As shown in FIG. 1B, a material body 30 including a complex oxide is formed over the lower electrode 20. As a method for forming the material body 30, a coating method and an LSMCD method can be given. As examples of the coating method, a spin coating method and a dipping method can be given. The material body 30 includes a sol-gel material and an MOD material. As the sol-gel material, a material having a crystallization temperature lower than that of the MOD material and having a crystal nucleus formation rate and a crystal growth rate higher than those of the MOD material is selected.

The sol-gel material may be prepared as described below. Metal alkoxides having four or less carbon atoms are mixed and subjected to hydrolysis and polycondensation. A strong M—O—M—O . . . bond is formed by hydrolysis and polycondensation. The resulting M—O—M bond has a structure similar to the ceramic crystal structure (perovskite structure). M represents a metal element (Bi, Ti, La, or Pb, for example), and O represents oxygen. A solvent is added to the product obtained by hydrolysis and polycondensation to obtain a material. The sol-gel material may be prepared in this manner.

As an example of the MOD material, a polynuclear metal complex material in which the elements of the ceramic film are continuously connected either directly or indirectly can be given. As a specific example of the MOD material, a metal salt of a carboxylic acid can be given. As examples of the carboxylic acid, acetic acid, 2-ethylhexanoic acid, and the like can be given. As examples of the metal, Bi, Ti, La, Pb, and the like can be given. The MOD material includes an M—O bond in the same manner as the sol-gel material. However, the M-O bond does not form a continuous bond differing from the sol-gel material obtained by polycondensation. Moreover, the bond structure is similar to the linear structure and completely differs from the perovskite structure.

In the material body 30, the sol-gel material and the MOD material may be adjusted at the stoichiometric composition of the complex oxide, and the mixture of these materials may include the metal material (Pb or Bi, for example) included in the complex oxide in an amount of at most 5% in excess of the stoichiometric composition. For example, since the metal material such as Pb or Bi bonds to oxygen at low temperature and vaporizes, 10 to 20% of Bi or Pb is included in the material body 30 as an excess additive in a conventional method in order to compensate for shortage during the crystallization process. However, the residual excess additive remaining after crystallization may enter between the crystals of a ceramic film 40 or between the crystal and the electrode, thereby causing the crystal quality to deteriorate.

In this manufacturing method, since the sol-gel material in which the configuration of the elements is similar to that of a crystal is mixed in advance with the MOD material in which the elements tend to move freely, the materials complementarily function during crystallization, whereby the amount of excess additive such as Pb or Bi can be reduced as much as possible. In more detail, the amount of excess additive can be reduced to 5% or less of the stoichiometric composition. This prevents the excess additive such as Pb or Bi remaining after crystallization of the material body 30 from entering between the crystals or between the lower electrode 20 and the crystal to form an affected layer.

In addition to the complex oxide, a paraelectric material having a catalytic effect for the complex oxide may be present in the material body 30 in a mixed state. If the paraelectric material is present in the material body 30 in a mixed state in addition to the complex oxide which makes up the ferroelectric, a part of the elements of the complex oxide is replaced by the element of the paraelectric material during the crystallization process of the complex oxide, whereby the crystallization temperature can be reduced.

As the paraelectric material, an oxide which includes Si or Ge in the elements or an oxide which includes Si and Ge in the elements may be used, for example. As such an oxide, a paraelectric material shown by ABOₓ or BOₓ in which the A site includes a single element or a composite element of Pb, Bi, Hf, Zr, V, or W and the B site includes a single element or a composite element of Si or Ge may be used. Specific examples include PbSiO family (Pb₅Si₃Oₓ or Pb₂Si₁Oₓ), PbGeO family (Pb₅Ge₃Oₓ or Pb₂Ge₁₁Oₓ), BiSiO family (Bi₄Si₃Oₓ or Bi₂Si₁Oₓ), BiGeO family (Bi₄Ge₃Oₓ or Bi₂Si₁Oₓ), ZrGeOₓ, HfGeOₓ, VGeOₓ, WGeOₓ, VSiOₓ, WSiOₓ, and the like. In the case of using Zr, Hf, V, or W in the A site, occurrence of oxygen vacancy in the ferroelectric is prevented.

The material body 30 is dried and presintered, if necessary.

As shown in FIGS. 1C and 1D, the material body 30 is crystallized by subjecting the material body 30 to a heat treatment to form the ceramic film 40. The sol-gel material generally has a crystallization temperature lower than that of the MOD material. The crystal nucleus formation rate and the crystal growth rate of the sol-gel material are higher than those of the MOD material. Therefore, in the crystallization process of the material body 30, which is the mixture of these materials, crystallization of the sol-gel material proceeds prior to crystallization of the MOD material, whereby the MOD material remains in the gap between the crystal nuclei formed by the sol-gel material. The MOD material is independently crystallized in the gap between the crystal nuclei of the sol-gel material, whereby the gap is filled with the MOD material. The sol-gel material differs from the MOD material in the direction in which the crystals tend to be oriented. Therefore, the sol-gel material and the MOD material interrupt the growth of the other in the crystallization process of these materials, whereby microcrystals are grown. As a result, the resulting ceramic film 40 exhibits excellent surface morphology.

In this manufacturing method, the temperature raising process of the heat treatment is performed at a pressure of two atmospheres or more in a low temperature region of 100° C. or less. It is known that Pb in a PbZrTiO family (hereinafter called “PZT”) complex oxide bonds to oxygen at a comparatively low temperature and easily scatters into the atmosphere (see Electrochemistry Handbook, fourth edition, page 128, Maruzen, 1985), for example. The manufacturing method of this embodiment aims at preventing such a metal material from scattering into the atmosphere. In the heat treatment, the atmosphere may be set at a pressure of two atmospheres or more before raising the temperature.

In this manufacturing method, since the metal material can be prevented from bonding to oxygen and being released by performing the heat treatment in an atmosphere containing oxygen at a volume ratio of 10% or less, the effect of preventing scattering of the metal material by pressurization can be further increased.

In the heat treatment, the temperature raising process may be performed at a pressure greater than the atmospheric pressure, and the temperature lowering process may be performed at a reduced pressure lower than the above pressure. This prevents the metal material from being released from the material body during the temperature raising process by pressurization, and prevents adhesion of impurities such as an excess material contained in the atmosphere to the ceramic film and formation of an affected layer in the ceramic film in the temperature lowering process by reducing the pressure from the pressurized state.

This method is also effective for crystallization of a complex oxide including Bi, which bonds to oxygen in a low temperature region and easily scatters into the atmosphere in the same manner as Pb, such as BiLaTiO family (hereinafter called “BLT”), BiTiO family (hereinafter called “BIT”), or SrBiTaO family (hereinafter called “SBT”) complex oxide.

In the heat treatment, a lower alloy film 24 may be formed between the lower electrode 20 and the ceramic film 40 during the temperature raising process. The lower alloy film 24 is formed of an alloy of the metal element which makes up the lower electrode 20 and the metal element contained in the material body 30. In this case, the additive metal material such as Pb or Bi contained in the material body 30 in an amount in excess of the stoichiometric composition of the complex oxide is used as the material for the lower alloy film 24.

In the case of using Pt as the material for the lower electrode 20, since the lattice constant of the lower electrode 20 (a, b, c: 3.96) does not coincide with the lattice constant of the PZT ceramic film 40 (a, b: 4.04, c: 4.14), a strain caused by lattice mismatch occurs at the interface between the lower electrode 20 and the ceramic film 40. Since this strain affects fatigue characteristics of the ferroelectric capacitor and the like, it is preferable that the strain be reduced as much as possible. As a substance having a lattice constant close to the lattice constant of the PZT ceramic film 40, PbPt₃ (a, b, c: 4.05) can be given. As alloy compounds made of Pb and Pt, PbPt (a, b: 4.24, c: 5.48), Pb₂Pt (a, b: 6.934, c: 5.764), and Pb₄Pt (a, b: 6.64, c: 5.97) can be given in addition to PbPt₃. Of these, since the lattice constant of PbPt₃ (a, b, c: 4.05) has a small mismatch with the lattice constant of the PZT ceramic film 40 (a, b: 4.04, c: 4.14), PbPt₃ is suitable as the material for the lower alloy film 24. In view of the above description, it is necessary for Pb suitable for the lower alloy film 24 have a large valence number. An oxide of Pb having a high valence number, such as PbO₂ or Pb₃O₄, tends to vaporize in a temperature region lower than the crystallization temperature of the material body 30. Specifically, it is necessary to perform the formation process of the lower alloy film 24 in the low temperature region in order to effectively use the metal material having a large valence number.

In the heat treatment of this manufacturing method, the lower alloy film 24 is formed between the lower electrode 20 and the material body 30 during crystallization, as shown in FIG. 1C, in a low temperature region of about 100 to 200° C. by raising the temperature at a low temperature rise rate of 100° C./min or less. The strain caused by lattice mismatch at the interface between each layer is reduced by the presence of the lower alloy film 24, thereby contributing to improvement of surface morphology of the crystallized ceramic film 40 and to improvement of fatigue characteristics of the resulting ferroelectric capacitor.

In the heat treatment, the material body 30 is crystallized after the formation process of the lower alloy film 24 by raising the temperature to form the ceramic film 40 over the lower alloy film 24.

As described above, in this method of manufacturing the first ferroelectric capacitor, the heat treatment for crystallization of the material body 30 includes the formation process of the lower alloy film 24 which reduces lattice mismatch at the interface between the ceramic film 40 and the lower electrode 20.

As shown in FIG. 1E, an upper electrode 50 is formed over the ceramic film 40 to obtain a ferroelectric capacitor. As the material and the formation method for the upper electrode 50, the material and the formation method for the lower electrode 20 may be applied.

As described above, according to this method of manufacturing the first ferroelectric capacitor, the complex oxide material can be prevented from being released to the atmosphere by the heat treatment in the pressurized and low oxygen concentration state. Moreover, since the lower alloy film 24 can be formed in a low temperature region in the temperature raising process of the heat treatment, surface morphology and electrical characteristics of the capacitor can be improved by reducing the strain at the interface between the ceramic film 40 and the lower electrode 20 by utilizing the lower alloy film 24.

In this method of manufacturing the first ferroelectric capacitor, after forming the upper electrode 50 over the substrate 10, a heat treatment for recovering the ferroelectric characteristics may be performed at a pressure of two atmospheres or more as post annealing. This improves the interfacial state between the ceramic film 40 and the upper electrode 50 and the lower electrode 20, whereby the ferroelectric characteristics can be recovered.

In this method of manufacturing the first ferroelectric capacitor, the ferroelectric capacitor may be patterned by etching or the like after forming the upper electrode 50 over the substrate 10, and a heat treatment for recovering the ferroelectric characteristics may be performed at a pressure of two atmospheres or more as post annealing. This enables the ferroelectric characteristics to recover from process damage during the etching step.

The post annealing may be performed by slowly heating the ferroelectric capacitor using furnace annealing (FA), or by rapidly heating the ferroelectric capacitor using a rapid thermal annealing method.

The above-described heat treatment may be performed in an atmosphere such as a gas inert to vaporization of the metal material which makes up the complex oxide, such as nitrogen, argon, or xenon. The effect of preventing vaporization of the metal material which makes up the complex oxide can be further increased by performing the heat treatment in such an atmosphere.

Pressurization may be performed in a plurality of stages in at least one of the temperature raising process and the temperature lowering process during the above-described heat treatment.

This method of manufacturing the first ferroelectric capacitor will be described below with reference to the drawings.

1.1. First Embodiment

In this embodiment, Pb(Zr_{0.35},Ti_{0.65})O₃ was deposited on a given substrate on which a Pt electrode was formed by using a spin coating method to conduct an examination.

In this embodiment, a material solution, in which Pb was added to a mixture of a sol-gel solution and an MOD solution adjusted to the stoichiometric composition of PZT (Zr/Ti=35/65) so that the amount of excess Pb was 5% at a molar ratio, was used. The Pb additive was used to form PbPt₃ at the interface between the Pt electrode and the PZT film.

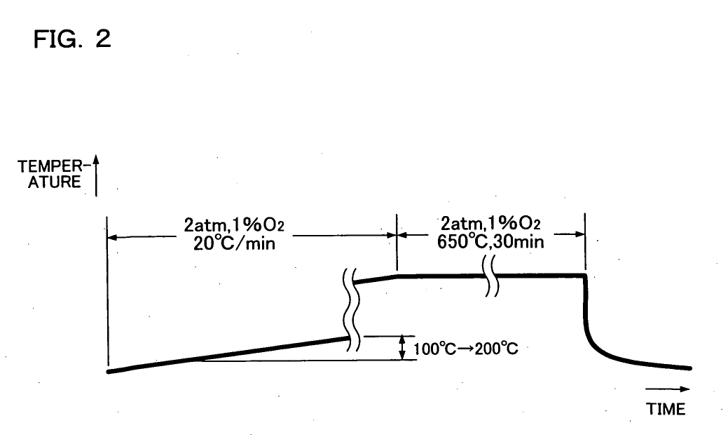

The material solution was applied to the Pt electrode by spin coating (3000 rpm, 30 sec), and presintered at 400° C. for five minutes. This step was repeated three times to form a material body with a thickness of 150 nm on the Pt electrode. As shown in FIG. 2, the material body was heated to 650° C. by furnace annealing (FA) in an atmosphere pressurized at two atmospheres and containing oxygen in an amount of 1% at a volume ratio, and crystallized by heating the material body for 30 minutes to obtain a PZT film having a perovskite structure. In the temperature raising process, the temperature rise rate was set at 20° C./min in order to form a PbPt₃ film, which is an alloy of Pt in the Pt electrode and Pb in the material body, in a low temperature region of about 100 to 200° C.

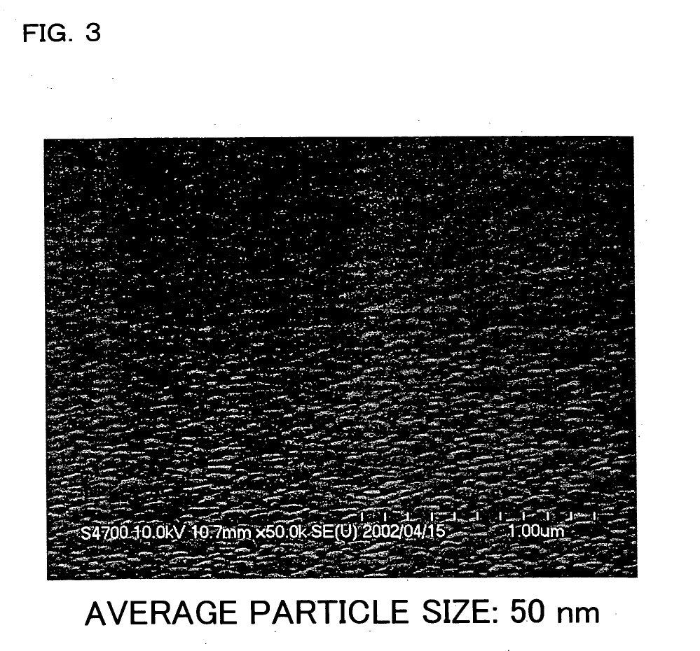

FIG. 3 is a micrograph of the surface of the resulting PZT film. As shown in FIG. 3, the PZT film has excellent surface morphology in which microcrystals having an average particle size of about 50 nm are uniformly distributed. The reason therefor is considered to be as follows. Specifically, lattice mismatch at the interface between the Pt electrode and the PZT film was reduced by the PbPt₃ layer formed at the interface between the Pt electrode and the PZT film, and Pb was prevented from being released during crystallization of the PZT film by the heat treatment performed in the pressurized and low oxygen concentration state.

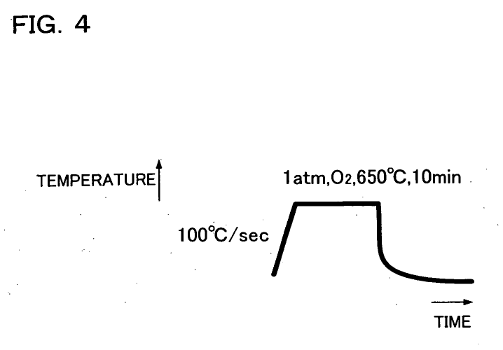

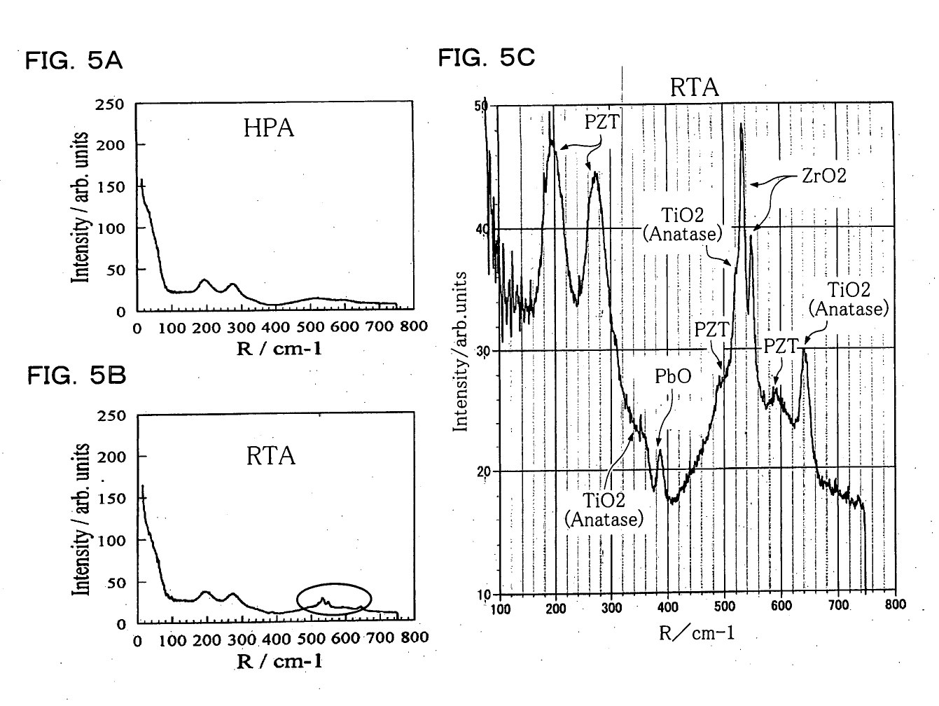

The Raman scattering spectrum of the PZT film was measured. In comparing the example with the prior art, the Raman scattering spectrum of a PZT film, which was crystallized by performing a heat treatment using a thermal annealing method in air without pressurization as shown in FIG. 4 (hereinafter called “Comparative Example 1”), was also measured. As shown in FIGS. 5A and 5B, the spectrum shape differs at 500 to 700 R/cm⁻¹ between the PZT film according to the manufacturing method of this embodiment and the PZT film of Comparative Example 1. This is because a heterophase was formed in the PZT film of Comparative Example 1. FIG. 5C is an enlarged view of the spectrum shape at 100 to 800 R/cm⁻¹ in the measurement result for the PZT film of Comparative Example 1. As shown in FIG. 5C, peaks indicating formation of a heterophase of PZT and an affected layer are observed for the PZT film of Comparative Example 1. The reason that such a significant difference was observed is considered to be because variation of the composition during the crystallization process of PZT was reduced by preventing vaporization of Pb by the heat treatment in the pressurized an low oxygen concentration state.

In this embodiment, a Pt electrode was formed on the crystallized PZT film as an upper electrode, and post annealing was performed at two atmospheres pressure to form a ferroelectric capacitor. The ferroelectric characteristics of the ferroelectric capacitor were evaluated.

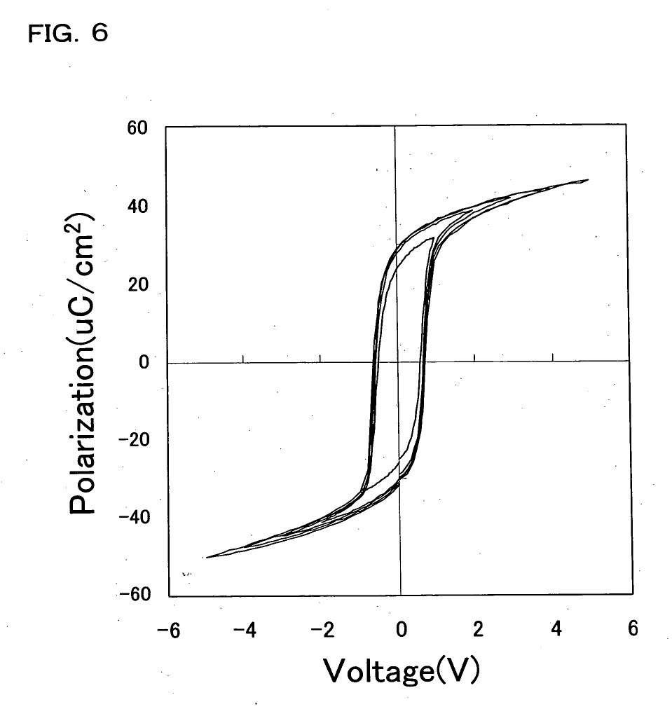

FIG. 6 shows hysteresis characteristics of the ferroelectric capacitor obtained by the manufacturing method of this embodiment. As shown in FIG. 6, the ferroelectric capacitor of this embodiment had a hysteresis shape with excellent squareness saturated at a low voltage of 2 V or less. The ferroelectric capacitor exhibited excellent polarization characteristics with a polarization Pr of about 30 C/cm².

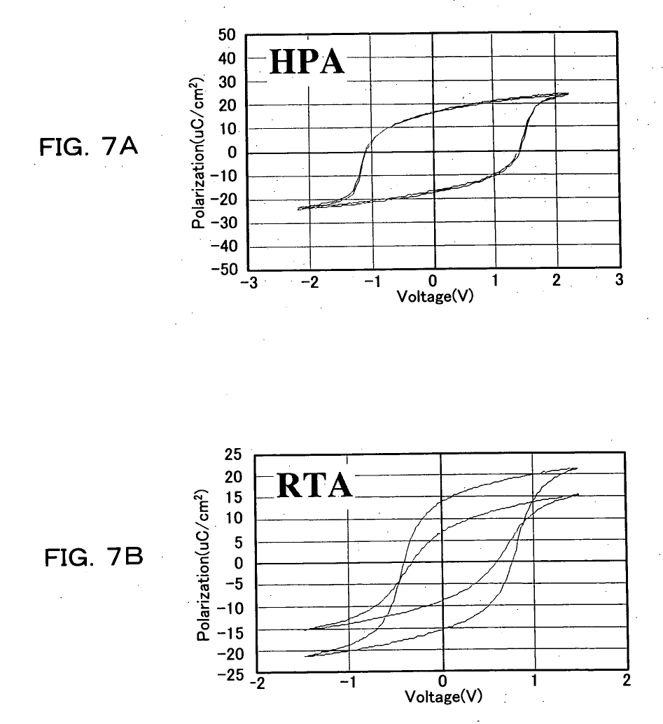

The fatigue characteristics of the ferroelectric capacitor obtained by the manufacturing method of this embodiment and a ferroelectric capacitor obtained by forming an upper electrode on the PZT film obtained by the manufacturing method of Comparative Example 1 were examined. FIGS. 7A and 7B are views showing hysteresis characteristics before and after the fatigue test, in which a triangular wave pulse at 2 and 66 Hz was applied to the ferroelectric capacitor ten times and a rectangular wave pulse at 1.5 V and 500 kHz was applied 10⁸ times or more to cause polarization reversal. FIG. 7A shows hysteresis characteristics of the ferroelectric capacitor obtained by the manufacturing method of this embodiment. FIG. 7B shows hysteresis characteristics of the ferroelectric capacitor obtained by Comparative Example 1. As shown in FIG. 7A, a change in hysteresis shape is not observed in the ferroelectric capacitor obtained by this embodiment before and after the test. On the contrary, as shown in FIG. 7B, polarization characteristics of the ferroelectric capacitor obtained by Comparative Example 1 decreased in the hysteresis shape after the test. This shows that the strain caused by lattice mismatch is reduced at the interface between the PZT film and the lower electrode, since the manufacturing method of this embodiment includes the formation process of the PbPt₃ alloy film in the crystallization process of the PZT film.

As described above, in this method of manufacturing the first ferroelectric capacitor, it was confirmed that the ceramic film is provided with excellent surface morphology by the heat treatment including the formation process of the lower alloy film in the pressurized and low oxygen concentration state in the crystallization step of the ceramic film, and the ferroelectric capacitor including the ceramic film has excellent hysteresis characteristics and fatigue characteristics.

1.2. Second Embodiment

In this embodiment, characteristics of PZT films formed on a Pt electrode using a spin coating method were examined for the case where a mixture of a sol-gel solution and an MOD solution was used as the material solution and for the case where either a sol-gel solution or an MOD solution was used as the material solution as Comparative Example. As the material solution, a material solution adjusted to the stoichiometric composition of PZT (Zr/Ti=35/65), to which Pb was added so that the amount of excess Pb was 5% at a molar ratio, was used. The heat treatment for crystallization was performed by raising the temperature of the material body obtained by applying the material solution to 650° C. by using FA in an atmosphere pressurized at two atmospheres and containing oxygen in an amount of 1% at a volume ratio, and heating the material body for 30 minutes.

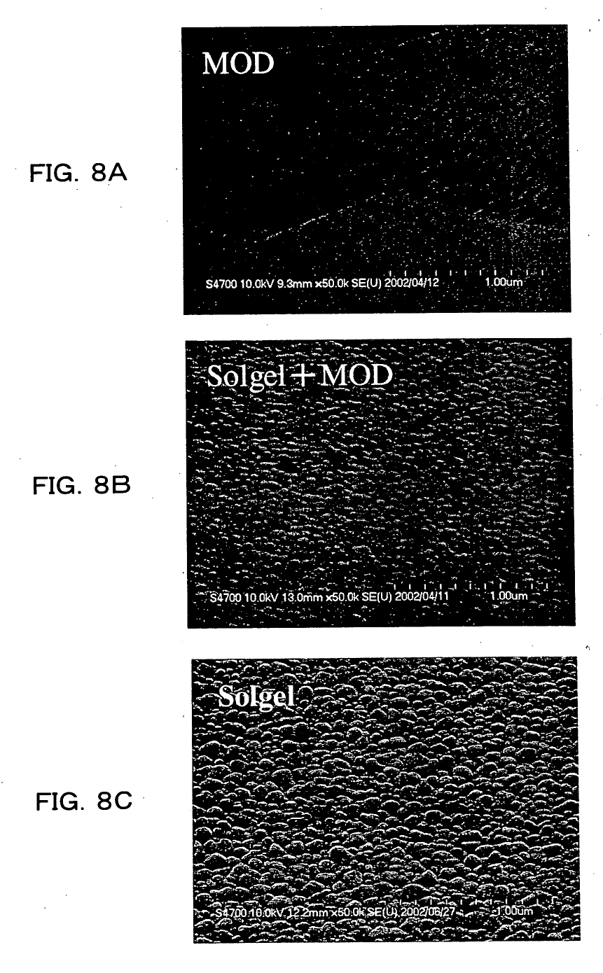

FIGS. 8A to 8C are micrographs of the surface of the PZT film obtained in this embodiment. FIG. 8A shows surface morphology of the PZT film of Comparative Example 3, in which only the MOD solution was used as the material solution. FIG. 8B shows surface morphology of the PZT film of this embodiment, in which the mixture of the sol-gel solution and the MOD solution was used as the material solution. FIG. 8C shows surface morphology of the PZT film of Comparative Example 2, in which only the sol-gel solution was used as the material solution.

In the micrographs shown in FIGS. 8A to 8C, surface morphology in which microcrystals having a small particle size are uniformly distributed is obtained when using the mixture of the sol-gel solution and the MOD solution in comparison with the case of using only the sol-gel solution or the MOD solution.

In this embodiment, characteristics of the PZT film obtained by using the mixture of the sol-gel solution and the MOD solution as the material solution were examined while changing the mixing ratio of the sol-gel solution to the MOD solution to 2:1, 1:1, and 1:2 at a molar ratio.

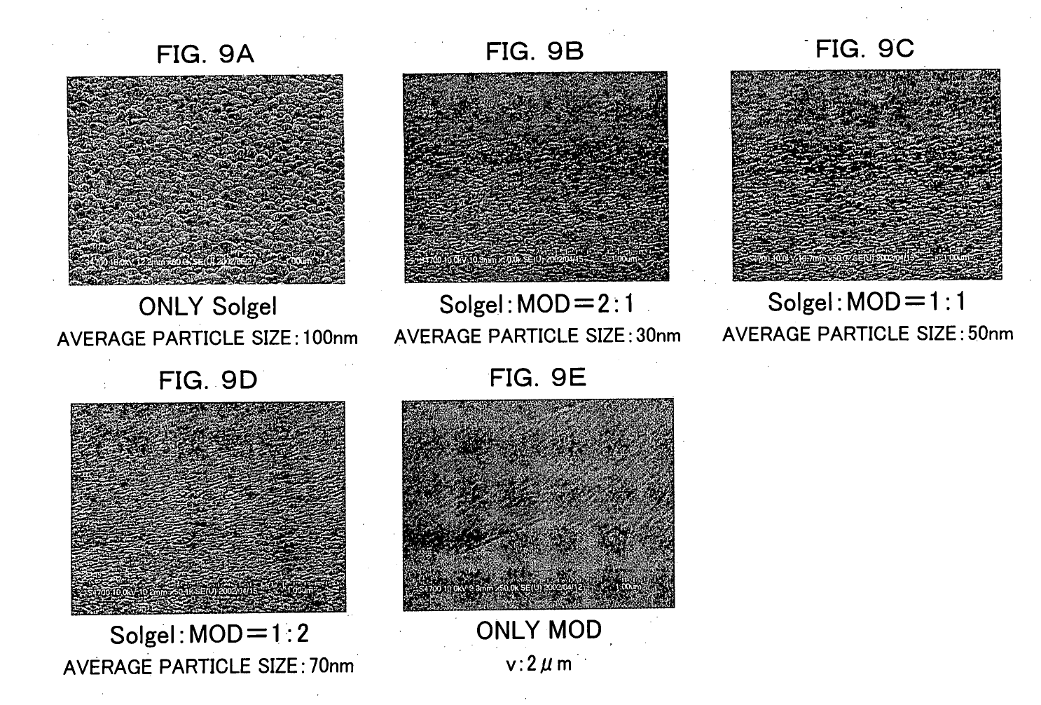

FIGS. 9A to 9E are micrographs of the surface of the PZT films obtained in this embodiment. FIGS. 9A and 9E show micrographs of a PZT film obtained by using only the sol-gel solution as the material solution (Comparative Example 2) and a PZT film obtained by using only the MOD solution as the material solution (Comparative Example 3) for comparison with the PZT film of this embodiment.

As shown in FIGS. 9A to 9E, the average particle size of the PZT films obtained by using the mixture of the sol-gel solution and the MOD solution is as small as 30 to 70 nm. On the contrary, the average particle size of the PZT film obtained by using only the sol-gel solution is as large as 100 nm, and the average particle size of the PZT film obtained by using only the MOD solution is as large as 2 μm. Specifically, the PZT film has excellent surface morphology, in which microcrystals are uniformly distributed, when using the mixture of the sol-gel solution and the MOD solution in comparison with the case of using only the sol-gel solution (Comparative Example 2) or the MOD solution (Comparative Example 3). The reason therefor is considered to be as follows. The density of initial crystal nuclei differs between the case of using only the sol-gel solution and the case of using only the MOD solution. However, since crystallization proceeds according to the initial crystal nuclei, the particle size of the crystal is increased. However, in the case of using the mixture of the sol-gel solution and the MOD solution, the initial crystal nuclei are formed by the sol-gel solution at high density, and the MOD solution is crystallized to fill the gap between the initial crystal nuclei. This reduces the particle size of the crystals.

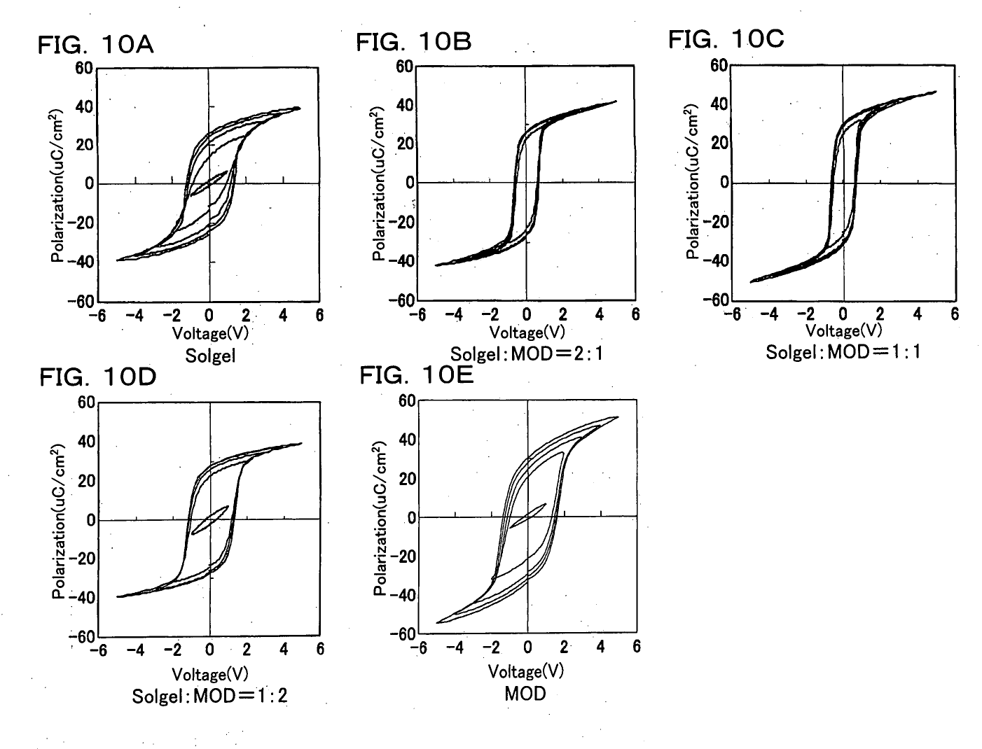

Electrical characteristics of a ferroelectric capacitor obtained by forming a Pt upper electrode on the above PZT film were examined. FIGS. 10B to 10D are views showing hysteresis characteristics of the ferroelectric capacitors obtained by this embodiment and Comparative Examples 2 and 3. FIG. 10A is a view showing hysteresis characteristics of the ferroelectric capacitor obtained by using only the sol-gel solution (Comparative Example 2). FIG. 10E is a view showing hysteresis characteristics of the ferroelectric capacitor obtained by using only the MOD solution (Comparative Example 3).

As shown in FIGS. 10A to 10E, a hysteresis shape with excellent squareness saturated at a low voltage of 2 V or less was obtained in the ferroelectric capacitors of this embodiment, in which the mixture of the sol-gel solution and the MOD solution was used as the material solution, at all mixing ratios in comparison with the ferroelectric capacitors in which only the sol-gel solution (Comparative Example 2) or only the MOD solution (Comparative Example 3) was used as the material solution.

Therefore, according to this embodiment, it was confirmed that surface morphology of the ceramic film can be improved and a ferroelectric capacitor having a hysteresis shape with excellent squareness can be manufactured when the mixing ratio of the sol-gel solution and the MOD solution in the material solution is in the range from 1:2 to 2:1 at amolar ratio.

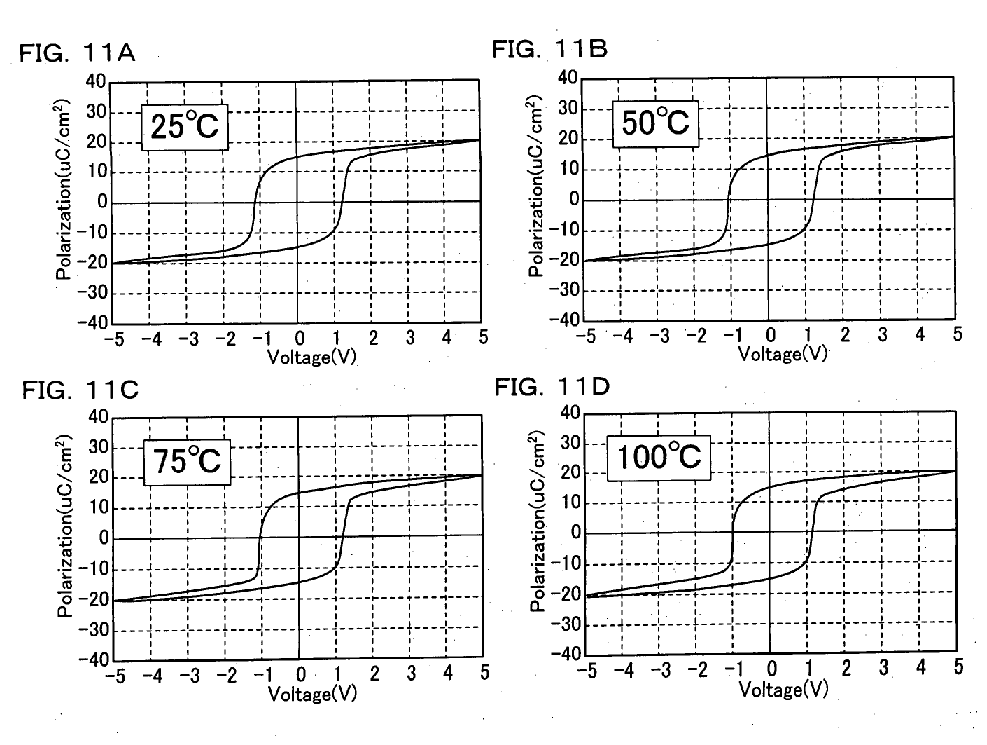

In this embodiment, temperature characteristics of the ferroelectric capacitor including the PZT film obtained by using the mixture of the sol-gel solution and the MOD solution (mixing ratio: 1:1) were measured. The temperature characteristics were obtained by measuring the hysteresis characteristics at 25 to 100° C. The results are shown in FIGS. 11A to 11D. As shown in FIGS. 11A to 11D, it was confirmed that the ferroelectric capacitor obtained by using the manufacturing method of this embodiment has excellent temperature characteristics, in which almost no change in hysteresis shape was observed even at a high temperature of 100° C.

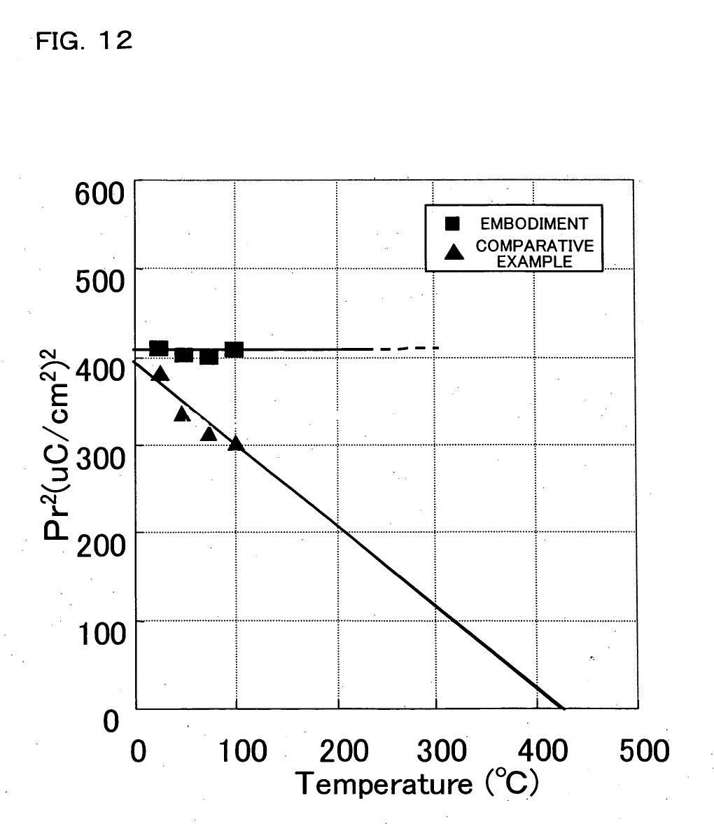

FIG. 12 is a graph in which the normalized polarization Pr [(μC/cm²)²] and the temperature [° C.] are respectively plotted on the vertical axis and the horizontal axis based on the above results. As shown in FIG. 12, the polarization of the ferroelectric capacitor including the PZT film formed by Comparative Example deteriorates as the temperature increases. On the contrary, the ferroelectric capacitor including the PZT film formed by the method of this embodiment showed an almost constant polarization even if the temperature changes, whereby excellent temperature characteristics the same as those of bulk PZT were obtained.

1.3. Third Embodiment

In this embodiment, Zr/Ti ratio dependence in the Pr(Zr,Ti)O₃ material solution was examined. In the first and second embodiments, the material solution in which the Zr/Ti ratio was 35/65 was used. In this embodiment, a material solution in which the Zr/Ti ratio was 20/80 was used, and electrical characteristics of ferroelectric capacitors including PZT films formed by using only the MOD solution as the material solution (Comparative Example 4) and using the mixture of the sol-gel solution and the MOD solution (mixing ratio=1:1) as the material solution were compared.

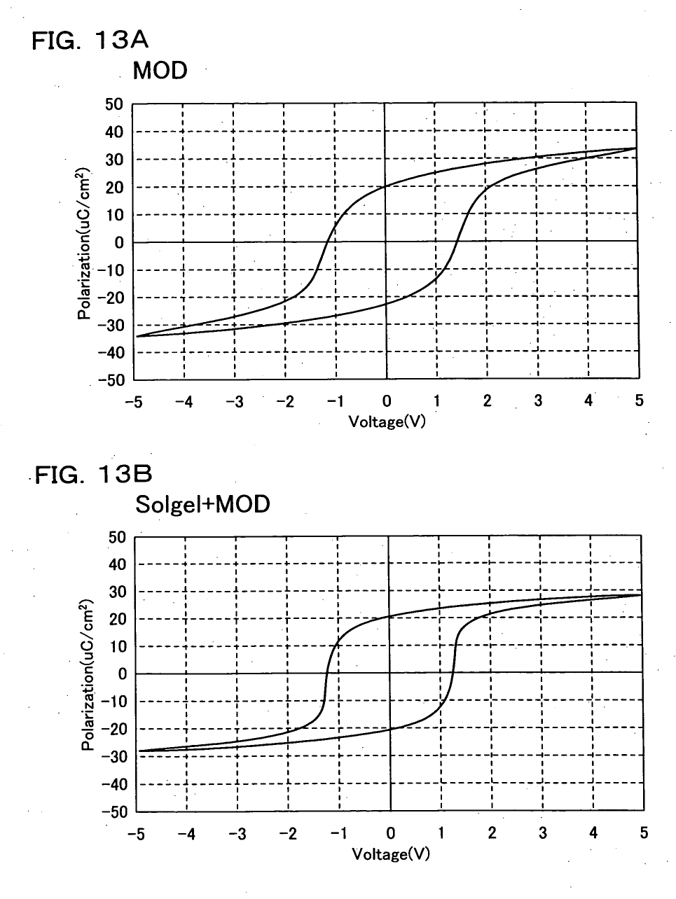

FIGS. 13A and 13B are views showing hysteresis characteristics of these ferroelectric capacitors. As shown in FIGS. 13A and 13B, even if the Zr/Ti ratio was set at 20:80, a hysteresis shape with excellent squareness saturated at a low voltage is obtained when using the mixture of the sol-gel solution and the MOD solution in comparison with the case of using only the MOD solution. Specifically, according to this embodiment, it was confirmed that the manufacturing method which uses the mixture of the sol-gel solution and the MOD solution as the material solution is effective, even if the Zr/Ti ratio is changed.

1.4. Fourth Embodiment

In this embodiment, the temperature of the heat treatment when crystallizing the PZT film was decreased to 580° C. and 425° C. in the manufacturing method described in the first embodiment, and the influence on electrical characteristics of the ferroelectric capacitor was examined.

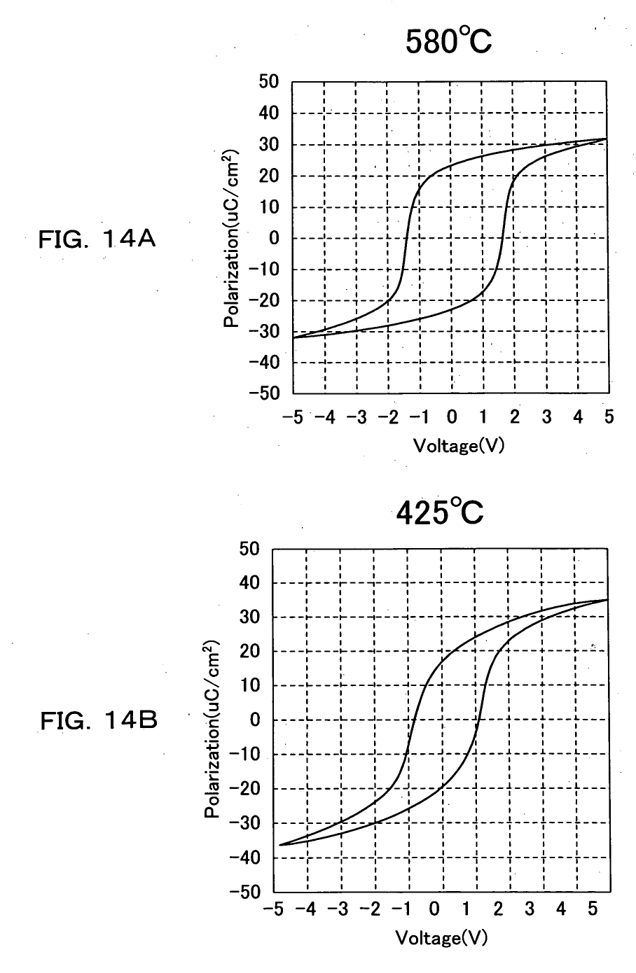

FIGS. 14A and 14B are views showing hysteresis characteristics of the ferroelectric capacitors including PZT films crystallized by the heat treatment at 580° C. and 425° C. As shown in FIGS. 14A and 14B, it was confirmed that a ferroelectric capacitor having hysteresis characteristics sufficient for practical application can be obtained even if the crystallization temperature was decreased.

1.5. Fifth Embodiment

In this embodiment, a Pb_{1.1}Zr_{0.1}Ti_{0.8}Si_{0.1}O₃ (PZTS1) film and a Pb_{1.1}Zr_{0.7}Ti_{0.2}Si_{0.1}O₃ (PZTS2) film were deposited on a Pt electrode by using a spin coating method to conduct an examination. The procedure for synthesizing a sol-gel solution of this embodiment is described below. The sol-gel solution was prepared by mixing a sol-gel solution for forming a PbZrTiO₃ (PZT) ferroelectric and a sol-gel solution for forming PbSiO₃ (PSO).

A thin film was formed by using a solution, in which 0.01 mol of PSO was added to 1 mol of a PZT sol-gel solution in which the amount of excess Pb was 0.5%, 10%, 15%, or 20%. A Pt coated Si substrate was used as the substrate. The sol-gel solution for forming a ferroelectric prepared by the above procedure was applied to the substrate by spin coating (from 500 rpm and 5 sec to 4000 rpm and 20 sec), dried in air (150° C., 2 min), and presintered (250° C., 5 min). These steps were repeated four times. The solution was then crystallized to form a thin film with a thickness of 100 nm.

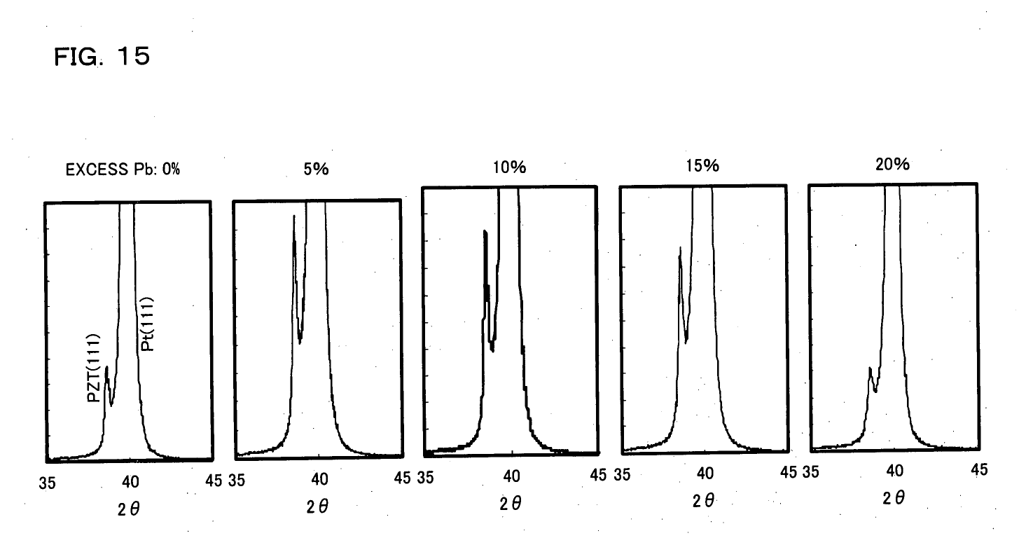

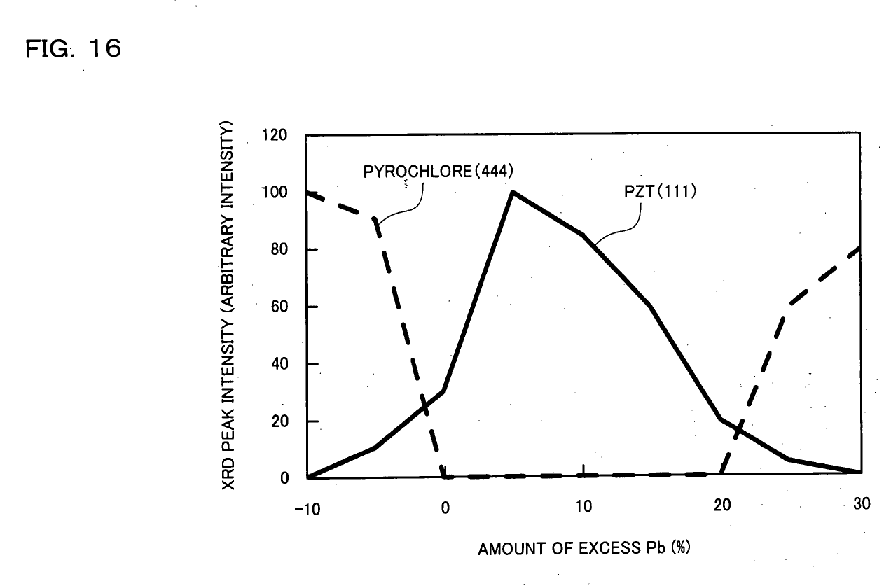

As a result, x-ray diffraction (XRD) patterns shown in FIG. 15 were obtained. As shown in FIG. 15, it was confirmed that maximum crystallinity was obtained when the amount of excess Pb was 5%. FIG. 16 shows the relationship between the XRD peak intensity and the amount of excess Pb. Since Pb easily volatilizes due to high vapor pressure, about 20% of an excess Pb component is generally added to the solution in advance in order to compensate for volatilization. However, in the case of using the solution to which 0.01 mol of PSO was added, it was found that it suffices that the amount of excess Pb added to the PZT sol-gel solution be about 5%. This suggests that PSO added in this embodiment prevents volatilization of the excess Pb component in the PZT sol-gel solution by unknown functions, and Pb in the PSO does not merely function as the excess Pb component.

In FIG. 15, a PZT single crystal is obtained when the amount of excess Pb was in the range of 0 to 20%. The maximum peak intensity (crystallinity) was obtained when the amount of excess Pb was 5%. In particular, when the amount of excess Pb was 0% and 20%, the peak intensity was weak in comparison with other cases, thereby resulting in inferior crystallinity. When the amount of excess Pb was 0% or less or 20% or more, a pyrochlore phase which is the heterophase appears as shown in FIG. 16.

Specifically, since Pb easily volatilizes due to high vapor pressure, the amount of Pb is insufficient with respect to the stoichiometric composition of PZT when the amount of excess Pb is less than 5%. Therefore, Pb in an amount in excess only to a certain extent promotes crystallization of PZT. However, in this embodiment, since the role of excess Pb is fully achieved by a small amount of excess Pb, 20% excess Pb, which is considered to be an optimum Pb value in a conventional method, is excessive and inhibits crystallization of PZT, whereby the XRD peak intensity becomes weak.

### 2. Second Ferroelectric Capacitor

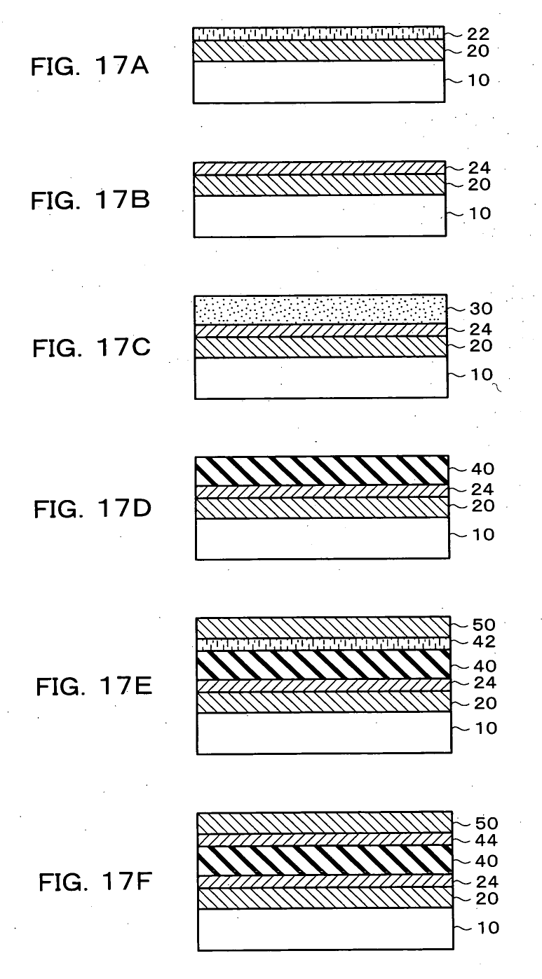

FIGS. 17A to 17F are cross-sectional views schematically showing manufacturing steps of a second ferroelectric capacitor according to one embodiment of the present invention. Note that components having substantially the same functions as those described in FIG. 1 are denoted by the same reference numbers and further description thereof is omitted.

In this method of manufacturing the second ferroelectric capacitor, fatigue characteristics of the ferroelectric capacitor are improved by providing a step of forming alloy films on the upper and lower surfaces of the ceramic film, and the crystal orientation of the ceramic film is improved by crystallizing the ceramic film by using a heat treatment using the rapid thermal annealing method.

In this manufacturing method, the lower electrode 20 is formed over the substrate 10 as shown in FIG. 17A. An oxide film 22 including an oxide (PbO₂ or BiO₂, for example) of a metal material (Pb or Bi, for example) which makes up a complex oxide (PZT, BIT, BLT, or SBT, for example) is formed over the lower electrode 20.

As shown in FIG. 17B, the oxide film 22 is subjected to a heat treatment at a pressure of two atmospheres or more to form the lower alloy film 24 made of a compound of the metal material for the lower electrode 20 (Pt or Ir, for example) and the metal material which makes up the complex oxide (Pb or Bi, for example). The heat treatment for forming the lower alloy film 24 is performed at a temperature lower than that of a heat treatment for crystallizing the ceramic film 40 described later in order to prevent the metal material which makes up the complex oxide from scattering into the atmosphere.

As shown in FIG. 17C, the material body 30 is formed on the lower alloy film 24. The material body 30 may include a sol-gel material and an MOD material in the same manner as in the manufacturing steps of the first ferroelectric capacitor. In the material body 30, the sol-gel material and the MOD material are preferably adjusted to the stoichiometric composition of the complex oxide, and the mixture of the materials preferably includes the metal material (Pb or Bi, for example) included in the complex oxide in an amount of at most 5% in excess of the stoichiometric composition. In this manufacturing method, since the lower alloy film 24 is formed before forming the material body 30, the metal material included in the complex oxide may not be excessively added to the material body 30.

In addition to the complex oxide, a paraelectric material having a catalytic effect for the complex oxide may be present in the material body 30 in a mixed state. If the paraelectric material is present in the material body 30 in a mixed state in addition to the complex oxide which makes up a ferroelectric, a part of the elements of the complex oxide is replaced by the element of the paraelectric material during the crystallization process of the complex oxide, whereby the crystallization temperature can be reduced.

As the paraelectric material, an oxide which includes Si or Ge in the elements or an oxide which includes Si and Ge in the elements may be used, for example.

As shown in FIG. 17D, the heat treatment for crystallizing the material body 30 is performed to form the ceramic film 40 made of the above complex oxide. The heat treatment is performed by using a rapid thermal annealing method in which the material body 30 is rapidly heated at a temperature rise rate of several tens of degrees per second. In the crystallization process of the complex oxide, if the temperature rise rate is low, initial crystal nuclei are formed at various angles, whereby the crystals of the ceramic film tend to be oriented at random. However, a high quality crystal film having excellent orientation can be obtained by rapidly heating the material body 30 by using the rapid thermal annealing method as in this method.

In the heat treatment for crystallization, the temperature raising process is performed at a pressure of two atmospheres or more in a low temperature region of 100° C. or less. This aims at preventing the metal material which vaporizes at a comparatively low temperature such as Pb or Bi from scattering into the atmosphere before crystallization. In the heat treatment, the atmosphere may be set at a pressure of two atmospheres or more before raising the temperature.

In this manufacturing method, since the metal material can be prevented from bonding to oxygen and being released by performing the heat treatment in an atmosphere containing oxygen at a volume ratio of 10% or less, the effect of preventing the metal material from scattering by pressurization can be further increased.

In the heat treatment, the temperature raising process may be performed at a pressure greater than the atmospheric pressure, and the temperature lowering process may be performed at a reduced pressure lower than the above pressure. This prevents the metal material from being released from the material body during the temperature raising process by pressurization, and prevents adhesion of impurities such as an excess material contained in the atmosphere to the ceramic film and formation of an affected layer in the ceramic film in the temperature lowering process by reducing the pressure from the pressurized state.

In this manufacturing method, in the case where the sol-gel material and the MOD material are included in the material body 30, the sol-gel material and the MOD material interrupt the growth of the other in the crystallization process of the materials, whereby microcrystals are grown. As a result, the resulting crystallized ceramic film 40 has excellent surface morphology.

As shown in FIG. 17E, an oxide film 42 including an oxide (PbO₂ or BiO₂, for example) of a metal material (Pb or Bi, for example) which makes up a complex oxide (PZT, BIT, BLT, or SBT, for example) is formed on the ceramic film 40. The upper electrode 50 is formed on the oxide film 42. The oxide film 42 is formed to form an alloy film at the interface between the ceramic film 40 and the upper electrode 50.

As shown in FIG. 17F, the above laminate is subjected to a heat treatment at a pressure of two atmospheres or more to form an upper alloy film 44 made of an alloy of the metal material for the complex oxide included in the oxide film 42 (Pb or Bi, for example) and the metal material for the upper electrode 50 (Pt or Ir, for example). The upper alloy film 42 has the same function as that of the lower alloy film 22. Specifically, the upper alloy film 42 reduces the strain caused by lattice mismatch between the ceramic film 40 and the upper electrode 50, whereby surface morphology of the ceramic film 40 and fatigue characteristics of the ferroelectric capacitor can be improved.

As described above, according to this method of manufacturing the second ferroelectric capacitor, the material for the complex oxide can be prevented from being released to the atmosphere by the heat treatment in the pressurized and low oxygen concentration state. Moreover, since the heat treatment for crystallization is performed by using the rapid thermal annealing method, a ferroelectric capacitor including a high quality ceramic film having excellent crystal orientation can be obtained by rapid heating. Furthermore, since the heat treatment for forming the lower alloy film 24 and the upper alloy film 44 is introduced, surface morphology and electrical characteristics of the capacitor can be improved by reducing the strain at the interface between the ceramic film 40 and the lower electrode 20 and the upper electrode 40 by utilizing the lower alloy film 24 and the upper alloy film 44.

In this method of manufacturing the second ferroelectric capacitor, after forming the upper electrode 50 over the substrate 10, a heat treatment for recovering the ferroelectric characteristics may be performed at a pressure of two atmospheres or more as post annealing. This enables the interfacial state between the ceramic film 40 and the upper electrode 50 and the lower electrode 20 to be improved, whereby the ferroelectric characteristics can be recovered.

In this method of manufacturing the second ferroelectric capacitor, the ferroelectric capacitor may be patterned by etching or the like after forming the upper electrode 50 over the substrate 10, and a heat treatment for recovering the ferroelectric characteristics may be performed at a pressure of two atmospheres or more as post annealing. This enables the ferroelectric characteristics to recover from process damage during the etching step.

The post annealing may be performed by slowly heating the ferroelectric capacitor using furnace annealing (FA), or by rapidly heating the ferroelectric capacitor using the rapid thermal annealing method.

The above-described heat treatment may be performed in an atmosphere such as a gas inert to vaporization of the metal material which makes up the complex oxide, such as nitrogen, argon, or xenon. The effect of preventing vaporization of the metal material which makes up the complex oxide can be further increased by performing the heat treatment in such an atmosphere.

Pressurization may be performed in a plurality of stages in at least one of the temperature raising process and the temperature lowering process during the above-described heat treatment.

A further detailed example of this manufacturing method will be described below with reference to the drawings.

2.1. Sixth Embodiment

In this embodiment, a ferroelectric capacitor including a Pb(Zr_{0.35},Ti_{0.65})O₃ complex oxide over a given substrate over which a Pt electrode was formed as a ceramic film was formed to conduct an examination.

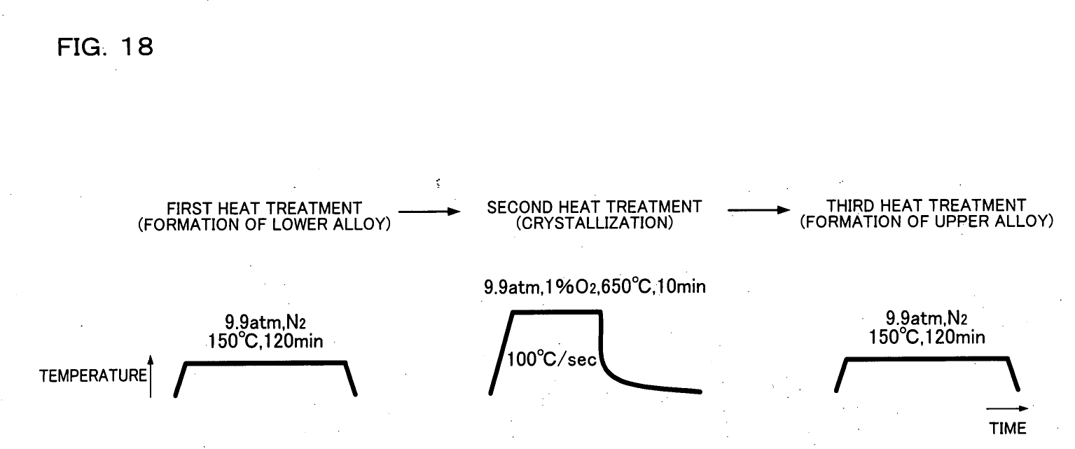

A sol-gel solution of 0.1 wt % for forming PbO₂ was applied to the Pt electrode by spin coating (3000 rpm, 30 sec). As shown in FIG. 18, the applied solution was subjected to a first heat treatment in a nitrogen atmosphere at a pressure of 9.9 atmospheres at 150° C. for 120 minutes to form a PbPt₃ film, which is an alloy of Pb as the metal material for the complex oxide and the Pt electrode as the lower electrode, on the Pt electrode.

A PZT sol-gel solution (Zr/Ti=35/65) adjusted to the stoichiometric composition was applied to the PbPt₃ film by spin coating (3000 rpm, 30 sec) and presintered at 400° C. for five minutes. This step was repeated three times to form a material body with a thickness of 150 nm on the Pt electrode.

As shown in FIG. 18, the material body was crystallized by performing a second heat treatment in which the material body was rapidly heated to 650° C. at a temperature rise rate of 100° C./sec in an atmosphere pressurized at 9.9 atmospheres and containing oxygen at a volume ratio of 1%, and heated at 650° C. for 10 minutes to form a PZT film having a perovskite structure.

A sol-gel solution of 0.1 wt % for forming PbO₂ was applied to the PZT film by spin coating (3000 rpm, 30 sec), and a Pt electrode was formed on the applied sol-gel solution as an upper electrode. As shown in FIG. 18, a third heat treatment was performed in a nitrogen atmosphere at a pressure of 9.9 atmospheres and a temperature of 150° C. for 120 minutes to form a PbPt₃ film, which is an alloy of Pb as the metal material for the complex oxide and Pt as the metal material for the upper Pt electrode, at the interface between the PZT film and the upper Pt electrode. Then, post annealing was performed by using the rapid thermal annealing method in a pressurized state in the same manner as in the second heat treatment to obtain a ferroelectric capacitor.

As a comparative example for the ferroelectric capacitor obtained by the manufacturing method of this embodiment, a ferroelectric capacitor (Comparative Example 5) was formed by using a material solution in which Pb was added to a sol-gel solution adjusted to the stoichiometric composition so that the amount of excess Pb was 20% at a molar ratio. The material solution was applied to the Pt electrode by spin coating (3000 rpm, 30 sec) and presintered at 400° C. for five minutes. This step was repeated three times to form a material body with a thickness of 150 nm. As shown in FIG. 4, the material body was heated to 650° C. at a temperature rise rate of 100° C./sec in an atmosphere set at the atmospheric pressure and containing a sufficient amount of oxygen by using the rapid thermal annealing method, and then heated for 10 minutes to obtain a PZT film on the Pt electrode. An upper electrode was formed on the PZT film, and post annealing was performed in a pressurized state by using the rapid thermal annealing method to obtain a ferroelectric capacitor of Comparative Example 5.

The fatigue characteristics of the ferroelectric capacitors obtained by the manufacturing method of this embodiment and the manufacturing method of Comparative Example 5 were examined by applying a triangular wave pulse at 2 and 66 Hz ten times and applying a rectangular wave pulse at 1.5 V and 500 kHz 108 times or more to cause polarization reversal.

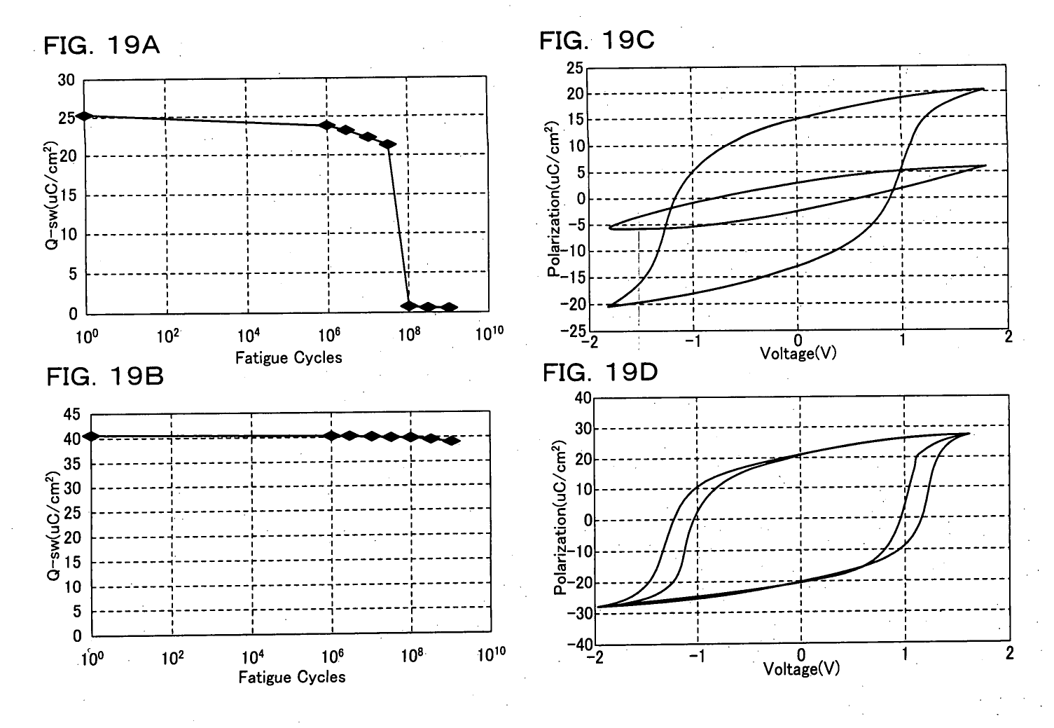

FIGS. 19A to 19D are views showing the fatigue characteristics. FIGS. 19A and 19C show the fatigue characteristics of the ferroelectric capacitor obtained by Comparative Example 5. FIGS. 19B and 19D show the fatigue characteristics of the ferroelectric capacitor obtained by using the manufacturing method of this embodiment.

As shown in FIG. 19A, the characteristics rapidly decrease in Comparative Example 5 near the point at which the number of polarization reversals exceeds 108. As shown in FIG. 19B, deterioration of the characteristics due to fatigue is not observed in this embodiment, even if the number of polarization reversals exceeds 10⁸. Changes in hysteresis characteristics before and after the fatigue test are compared as shown in FIGS. 19C and 19D. As shown in FIG. 19C, the ferroelectric capacitor of Comparative Example 5 shows hysteresis characteristics only to a small extent after the fatigue test. As shown in FIG. 19D, the ferroelectric capacitor of this embodiment shows an excellent hysteresis shape having squareness equal to that before the fatigue test. The reason therefor is considered to be as follows. In the ferroelectric capacitor of this embodiment, since the alloy films are formed at the interface between the PZT film and the upper and lower electrodes, the strain caused by lattice mismatch is reduced. In the manufacturing method of this embodiment, since the heat treatment for crystallization is performed by rapidly heating the material body using the rapid thermal annealing method in the pressurized and low oxygen concentration state, Pb is prevented from being released during the crystallization process, whereby a highly oriented and uniform PZT film can be obtained. This contributes to improvement of the fatigue characteristics.

As described above, it was confirmed that a ferroelectric capacitor can be provided with excellent hysteresis characteristics and fatigue characteristics, since the method of manufacturing the second ferroelectric capacitor includes the formation process of the alloy films on the upper and lower surfaces of the ceramic film, and the crystallization process of the ceramic film in which the heat treatment is performed by using the rapid thermal annealing method in a pressurized and low oxygen concentration state.

### 3. Application to Semiconductor Device

Application examples of the above-described manufacturing methods to a semiconductor device will be described below.

3.1. Application Example 1

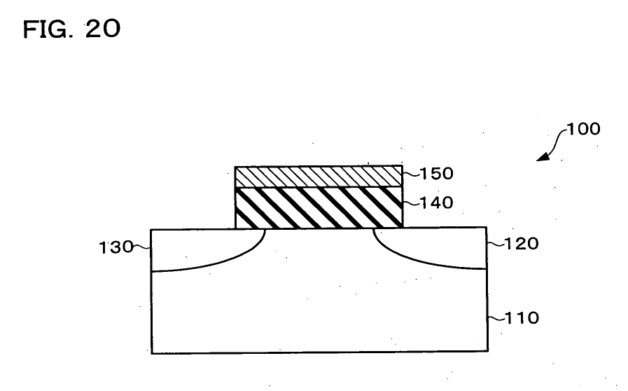

FIG. 20 is a cross-sectional view schematically showing a semiconductor device 100 to which a ceramic film obtained by the above-described manufacturing methods is applied.

The semiconductor device 100 has an MISFET (metal-insulating film-semiconductor FET) structure in which a gate insulating film 140 and a gate electrode 150 are formed over a semiconductor substrate 110 in which source and drain regions 120 and 130 are formed.

In the semiconductor device 100, the source and drain regions 120 and 130 may be formed by using a conventional semiconductor manufacturing method. The gate electrode 150 may be formed by using a conventional semiconductor manufacturing method. A ferroelectric ceramic film formed by using the method of manufacturing a ferroelectric capacitor described in the above embodiment is used as the gate insulating film 140. In order to form an excellent interface between the gate insulating film 140 and the semiconductor substrate 110, a paraelectric layer or a double layer consisting of a metal and a paraelectric may be inserted between the gate insulating film 140 and the semiconductor substrate 110.

The semiconductor device 100 functions as a semiconductor memory by reading data utilizing a change in drain current based on polarization of the gate insulating film 140 as the ferroelectric ceramic film. Since the gate insulating film 140 of the semiconductor device 100 is formed of a ferroelectric ceramic film obtained by the above manufacturing methods, the gate insulating film 140 has hysteresis characteristics saturated at a low voltage. Therefore, the semiconductor device 100 can be driven at high speed or at a low voltage, whereby power consumption of the device can be reduced.

3.2. Application Example 2

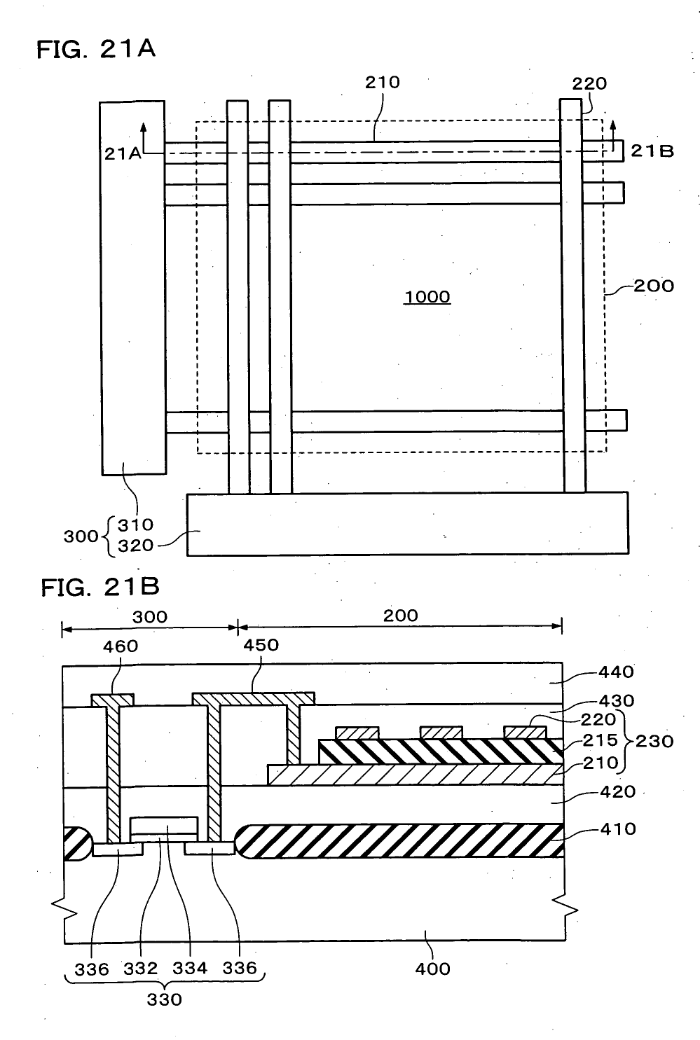

FIGS. 21A and 21B are views schematically showing a semiconductor device 1000 using a ferroelectric capacitor obtained by the above manufacturing methods. FIG. 21A shows a planar shape of the semiconductor device 1000. FIG. 21B shows a cross section of the semiconductor device 1000 shown in FIG. 21A.

As shown in FIG. 21A, the semiconductor device 1000 includes a memory cell array 200 and a peripheral circuit section 300. The memory cell array 200 and the peripheral circuit section 300 are formed in different layers. The peripheral circuit section 300 is disposed on a semiconductor substrate 400 in a region differing from the memory cell array 200. As a specific example of the peripheral circuit section 300, a Y gate, sense amplifier, input-output buffer, X address decoder, Y address decoder, or address buffer can be given.

In the memory cell array 200, lower electrodes 210 (wordlines) for selecting rows and upper electrodes 220 (bitlines) for selecting columns are arranged to intersect. The lower electrodes 210 and the upper electrodes 220 are in the shape of stripes formed of a plurality of linear signal electrodes. The signal electrodes may be formed so that the lower electrodes 210 function as bitlines and the upper electrodes 220 function as wordlines.

As shown in FIG. 21B, a ferroelectric ceramic film 215 is disposed between the lower electrode 210 and the upper electrode 220. In the memory cell array 200, a memory cell which functions as a ferroelectric capacitor 230 is formed in a region in which the lower electrode 210 intersects the upper electrode 220. The ferroelectric capacitor 230 is formed by the above-described manufacturing method. Therefore, alloy films made of a compound of the material for the ferroelectric ceramic film 215 and the material for the lower electrode 210 or the upper electrode 220 are formed at the interface between the ferroelectric ceramic film 215 and the lower electrode 210 and the upper electrode 220. It suffices that the ferroelectric ceramic film 215 be disposed at least at the intersecting region of the lower electrode 210 and the upper electrode 220.

In the semiconductor device 1000, a second interlayer dielectric 430 is formed to cover the lower electrode 210, the ferroelectric layer 215, and the upper electrode 220. An insulating protective layer 440 is formed on the second interlayer dielectric 430 so as to cover interconnect layers 450 and 460.

As shown in FIG. 21A, the peripheral circuit section 200 includes various circuits for selectively writing or reading data into or from the memory cell 200. For example, the peripheral circuit section 200 includes a first driver circuit 310 for selectively controlling the lower electrode 210, a second driver circuit 320 for selectively controlling the upper electrode 220, and a signal detection circuit (not shown) such as a sense amplifier, for example.

As shown in FIG. 21B, the peripheral circuit section 300 includes a MOS transistor 330 formed on the semiconductor substrate 400. The MOS transistor 330 includes a gate insulating film 332, a gate electrode 334, and source/drain regions 336. The MOS transistors 330 are isolated by an element isolation region 410. A first interlayer dielectric 410 is formed over the semiconductor substrate 400 over which the MOS transistor 330 is formed. The peripheral circuit section 300 is electrically connected with the memory cell array 200 through an interconnect layer 51.

An example of write and read operations of the semiconductor device 1000 is described below.

In the read operation, a read voltage is applied to the capacitor of the selected memory cell. This also serves as a write operation of “0”. At this time, current flowing through the selected bitline or a potential when causing the bitline to be in a high impedance state is read by the sense amplifier. A given voltage is applied to the capacitors of the unselected memory cells in order to prevent occurrence of crosstalk during reading.

In the write operation, in the case of writing “1”, a write voltage which causes the polarization state to be reversed is applied to the capacitor of the selected memory cell. In the case of writing data “0”, a write voltage which does not cause the polarization state to be reversed is applied to the capacitor of the selected memory cell, whereby the “0” state written during the read operation is retained. A given voltage is applied to the capacitors of the unselected memory cells in order to prevent occurrence of crosstalk during writing.

In the semiconductor device 1000, the ferroelectric capacitor 230 formed by the above manufacturing methods has hysteresis characteristics saturated at a low voltage. Therefore, the semiconductor device 1000 can be driven at a low voltage or at high speed, whereby power consumption of the devices can be reduced. The ferroelectric capacitor 230 has excellent fatigue characteristics. Therefore, according to the semiconductor device 1000, reliability of the device can be increased, whereby the yield can be improved.

The embodiments of the present invention are described above. However, the present invention is not limited to the above embodiments. Various modifications and variations are possible within the scope of the present invention.

What is claimed is:

1. A method of manufacturing a ceramic film, comprising:
crystallizing a material body including a complex oxide by performing heat treatment on the material body at a pressure of two atmospheres or more,
wherein the complex oxide includes lead (Pb) or bismuth (Bi) as an element; and
wherein the material body is a mixture of a sol-gel material and a metallo-organic decomposition (MOD) material in which at least Pb or Bi in the complex oxide is in an amount of at most 5 percent in excess of Pb or Bi in the stoichiometric composition.

2. The method of manufacturing a ceramic film as defined in claim 1,
wherein each of the sol-gel material and the MOD material includes elements of the complex oxide other than Pb and Bi with the stoichiometric composition.

3. The method of manufacturing a ceramic film as defined in claim 1,
wherein the material body includes a paraelectric material having a catalytic effect on the complex oxide.

4. The method of manufacturing a ceramic film as defined in claim 3,
wherein the paraelectric material includes an oxide including silicon (Si) or germanium (Ge), or an oxide including Si and Ge.

5. The method of manufacturing a ceramic film as defined in claim 1,
wherein the heat treatment is performed in an atmosphere including oxygen having a volume ratio of 10 percent or less by a rapid thermal annealing.

6. A ceramic film manufactured by the method as defined in claim 1.

7. A semiconductor device comprising the ceramic film as defined in claim 6 as a gate insulating film.

8. A method of manufacturing a ferroelectric capacitor, comprising:
forming a lower electrode over a substrate;
forming a ceramic film over the lower electrode by crystallizing a material body including a complex oxide by performing heat treatment on the material body at a pressure of two atmospheres or more; and
forming an upper electrode over the ceramic film,
wherein the complex oxide includes lead (Pb) or bismuth (Bi) as an element; and
wherein the material body is a mixture of a sol-gel material and a metallo-organic decomposition (MOD) material in which at least Pb or Bi in the complex oxide is in an amount of at most 5 percent in excess of Pb or Bi in the stoichiometric composition and other elements of the complex oxide are included with the stoichiometric composition.

9. The method of manufacturing a ferroelectric capacitor as defined in claim 8,
wherein each of the sol-gel material and the MOD material includes the elements of the complex oxide other than Pb and Bi with the stoichiometric composition.

10. The method of manufacturing a ferroelectric capacitor as defined in claim 8,
wherein the material body includes a paraelectric material having a catalytic effect on the complex oxide.

11. The method of manufacturing a ferroelectric capacitor as defined in claim 10,
wherein the paraelectric material includes an oxide including silicon (Si) or germanium (Ge), or an oxide including Si and Ge.

12. The method of manufacturing a ferroelectric capacitor as defined in claim 8,
wherein the heat treatment is performed in an atmosphere including oxygen having a volume ratio of 10 percent or less by a rapid thermal annealing.

13. The method of manufacturing a ferroelectric capacitor as defined in claim 8,
wherein a temperature raising step in the heat treatment is performed at the rate of 100° C./min or less; and
wherein a lower alloy film formed of a compound of Pb or Bi in the material body and a metal element of the lower electrode is formed between the lower electrode and the ceramic film in the temperature raising step.

14. The method of manufacturing a ferroelectric capacitor as defined in claim 8,
wherein another heat treatment for recovering ferroelectric characteristics is performed at a pressure of two atmospheres or more after forming at least the upper electrode.

15. The method of manufacturing a ferroelectric capacitor as defined in claim 8,
wherein another heat treatment for recovering ferroelectric characteristics is performed at a pressure of two atmospheres or more after etching at least the ceramic film.

16. A ferroelectric capacitor manufactured by the method as defined in claim 8.

17. A semiconductor device comprising the ferroelectric capacitor as defined in claim 16.
